(19) United States
(12) Patent Application Publication
(10) Pub. No.: US 2016/0271732 A1
(43) Pub. Date: Sep. 22, 2016

(54) METHOD OF HIGH RATE DIRECT MATERIAL DEPOSITION

(71) Applicant: DM3D TECHNOLOGY, LLC, Auburn Hills, MI (US)

(72) Inventor: BHASKAR DUTTA, TROY, MI (US)

(21) Appl. No.: 15/074,400

(22) Filed: Mar. 18, 2016

Related U.S. Application Data
(60) Provisional application No. 62/135,422, filed on Mar. 19, 2015.

(51) Int. Cl. B23K 26/342; H05B 6/02; B23K 26/60; C23C 26/00; B23K 26/144

(52) U.S. Cl. CPC B23K 26/342; C23C 26/00; B23K 26/144; B23K 26/60; H05B 6/02; B33Y 10/00

(57) ABSTRACT

A method of performing direct material deposition onto a metallic substrate uses a source of an energy beam. A nozzle is coordinated with the source of the energy beam for infusing material relative to the energy beam generated by the source. The energy beam creates a melt pool on the metallic substrate. The source of the energy beam and the nozzle move along a predetermined path to generate a material deposition bead upon the substrate. A pre-heater is provided that is cooperatively controlled with the source of the energy beam and the nozzle. The pre-heater is moved along the predetermined path preceding the energy beam for heating the metallic substrate prior to the energy beam generating the melt pool. The nozzle infuses the melt pool with material for creating a direct material deposition bead upon the metallic substrate.

### PRIOR APPLICATIONS

The present application claims priority to U.S. Provisional Patent Application No. 62/135,422 filed on Mar. 19, 2015, the contents of which are included herein by reference.

### TECHNICAL FIELD

The present invention relates generally toward a method of performing direct material deposition upon a metallic substrate. More specifically, the present invention relates toward a high speed method of performing direct material deposition upon metallic substrate.

### BACKGROUND

Direct material deposition such as, for example, direct metal deposition, and equivalent 3D printing and additive manufacturing processes are becoming more widely accepted as viable manufacturing processes. One such example includes performing direct material deposition upon existing substrates to generate a three dimensional component. However, the direct material deposition process is known to be slow, specifically when compared to castings, forging, and machining. The slow rate of deposition has prevented wide acceptance across various manufacturing industries, particularly when manufacturing large components.

The slow rate of deposition, which requires melting part of a substrate onto which the deposition occurs by way of an energy beam such as, for example, a laser is time-consuming Raising a temperature of the substrate from ambient temperature to a temperature required for quality direct material deposition is known to be slow when relying merely on an energy beam. This time-consuming process has prevented the wider use of direct material deposition, particularly on large components or work pieces requiring a significant amount of material to acquire a desired dimensional configuration. Therefore, it would be desirable to provide a method for increasing the speed of direct material deposition and equivalent additive manufacturing processes to reduce cycle time and enable the process to be used on large components.

### SUMMARY

A method of performing direct material deposition onto a metallic substrate uses a source of an energy beam. A nozzle is coordinated with the source of the energy beam for delivering material relative to the energy beam generated by the source. The energy beam creates a melt pool on the metallic substrate. The source of the energy beam and the nozzle move along a predetermined path for generating a material deposition bead upon the substrate. A pre-heater is provided that is cooperatively controlled with the source of the energy beam and the nozzle. The pre-heater is moved along the predetermined path preceding the energy beam for heating the metallic substrate prior to the energy beam generating the melt pool. The nozzle infuses the melt pool with material for creating a direct material deposition bead upon the metallic substrate.

The heating element of the present invention is of the type that rapidly heats the metallic substrate to a temperature nearing the substrate's liquidus temperature. As such, the energy beam more rapidly forms a desirable melt pool upon the metallic substrate than can be formed upon a substrate disposed in an ambient temperature providing the ability to move the source of the energy beam more rapidly along a predetermined path. Therefore, cycle time for performing direct material deposition upon a large surface area of a substrate is significantly reduced providing for a more cost-effective deposition. It is believed that large components not previously thought suitable for direct material deposition are now economically feasible due to the reduced cycle time provided by the method of the present invention.

### BRIEF DESCRIPTION OF THE DRAWINGS

Other advantages of the present invention will be readily appreciated, as the same becomes better understood by reference to the following detailed description when considered in connection with the accompanying drawings, wherein:

FIG. 1 shows apparatus used to practice the method of the present invention.

FIG. 2 shows a laser beam on the present invention forming a melt pool;

FIG. 3 shows the nozzle injecting material into the melt pool to form a direct material deposition bead; and

FIG. 4 shows a cross-sectional view of the fully formed and machined direct material deposit structure.

### DETAILED DESCRIPTION

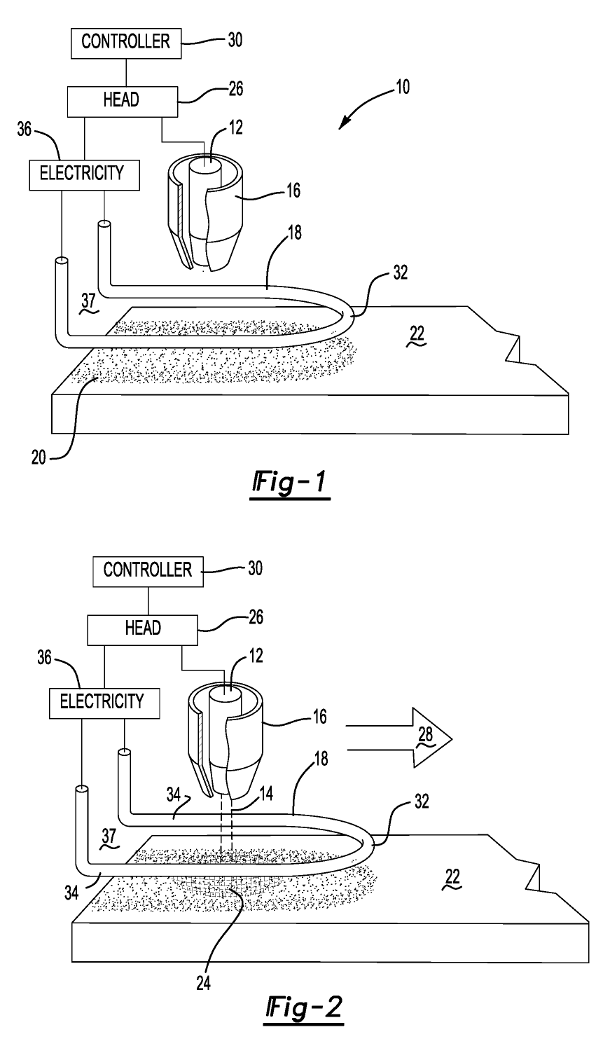

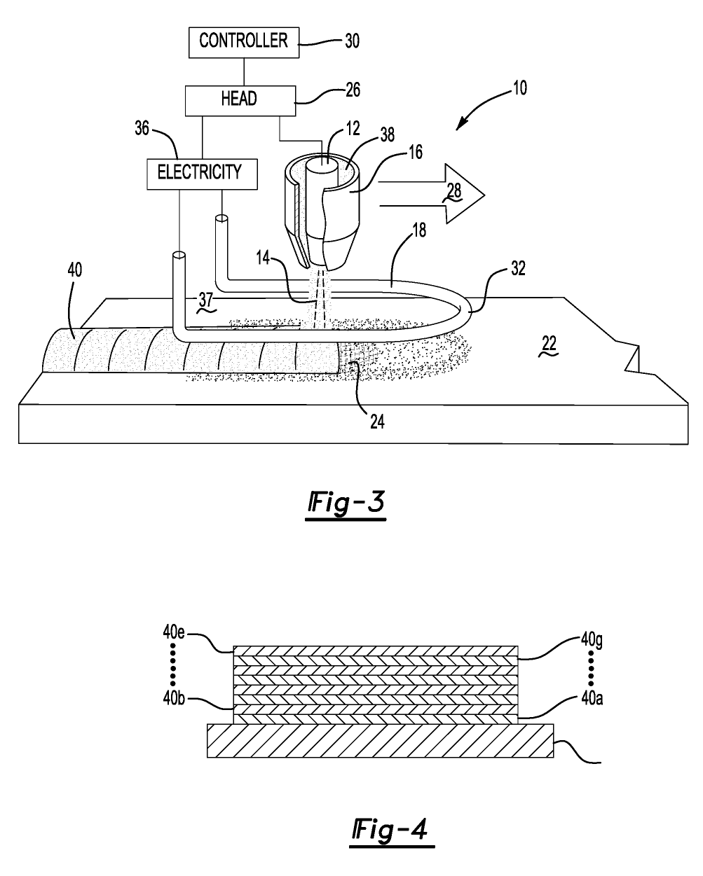

Referring to FIG. 1, an apparatus used to practice the method of the present invention is generally shown at 10. The apparatus includes a source 12 for generating an energy beam 14 (FIGS. 2, 3). In this embodiment, the source 12 is contemplated to be a laser that generates a laser beam 14. However, various other sources capable of generating an energy beam are included within the scope of this invention, including, but not limited to, an electron beam, a tungsten arc, and a plasma jet. A nozzle 16 infuses powdered material cooperably with the source 12 of the energy beam 14 as will be described further herein below.

A preheater 18 is controlled in a coordinated manner with the source 12 of the energy beam 14 and the nozzle 16. The preheater 18 takes the form of an induction coil, or an equivalent that makes use of electrically created magnetic field for rapidly heating the metallic substrate. As such, the preheater 18 generates a heated zone 20 on a metallic substrate 22 onto which a direct material deposition manufacturing process is intended. The preheated zone 20 is disposed at a temperature below the solidus state of a substrate 22. It can be appreciated that the composition of the substrate 22 dictates the temperature at which the preheater 18 heats the heated zone 20. For example, different alloys include different liquidus and solidus temperatures. It should be further understood that a substrate could include exotic alloys having some non-metallic content, which could also alter the liquidus temperature and the solidus temperature of the substrate composition.

Referring now to FIG. 2, the source of the energy beam 12 generates an energy beam 14 to develop a melt pool 24 in the heated zone 20 of the substrate 22. As set forth above, the melt pool 24 develops rapidly because the temperature of the substrate 22 has already been increased to its sub-liquidus temperature in the heated zone 20 by the preheater 18. The preheater 18 and the source of heat energy 12 and nozzle 16 are optionally integrated in a common head 26 so that the preheater 18 moves in unison with the source 12 of the energy beam 14 along a predetermined path in the direction of arrow 28. A controller 30 dictates movement of the head 26, the source 12 and the nozzle 16. Alternatively, the preheater 18, the source 12 of the energy beam 14 and the nozzle 16 are not disposed on a common head and movement is controlled independently by the controller 30.

The preheater 18, in this embodiment, is defined as a u-shape element having a leading portion 32 extending into opposing legs 34, each of which is interconnected with a source of electricity 36 to generate the induction current necessary to provide heat to the heated zone 20 of the substrate 22. As such, the heated zone 20 encompasses the melt pool 24, and substantially surrounds the nozzle 16. The preheater 18 defines a following opening 37 between the opposing legs 34 so that heat is not generated following the melt pool 24 as it develops in the direction of arrow 28 as will be described further herein below.

Referring now to FIG. 3, the process by which the direct material deposition occurs is best represented. The nozzle 16 infuses powdered material 38 into the energy beam 14 and the melt pool 24. The powdered material 38 differs from that defining the substrate 22 to provide enhanced physical characteristics to the substrate 22. The powdered material 38 includes alloys, polymers, and alloys having composite content to achieve desirable material properties. A bead 40 forms upon the melt pool 24 as the head 26 moves the preheater 18, the source 12 of the energy beam 14 and the nozzle 16 along the predetermined path in the direction of arrow 28. Once the bead 40 develops, it is desirable that the bead 40 cools rapidly. Therefore, it is not desirable for the preheater 18 to reheat the bead 40 as it forms and solidifies. Thus, the preheater 18 defines the opening 36 following the melt pool 24 as the preheater 18 moves along the predetermined path defined by arrow 28. It should be apparent the preheater 18 simultaneously heats the heated zone 20 of the substrate 22 while the energy beam 14 generates the melt pool 24 within the heated zone 20.

In most embodiments, it is desirable to provide direct material deposition in multiple layers to build a three-dimensional product to desired dimensions. As such, multiple passes along the predetermined path identified by arrow 28 are employed. Therefore, the bead 40 is again heated by the leading portion of 32 of the preheater 18 to reduce the amount of time required to form a melt pool 24 onto the bead 40. In one embodiment, each subsequent bead layer is reheated by the preheater 18 during direct material deposition to further reduce process cycle time. Alternatively, the preheater 18 only intermittently reheats the bead 40 when the bead 40 retains sufficient heat energy to rapidly form a melt pool 24.

Using the process set forth above, multiple layers of the bead 40a-40e are sequentially deposited along the predetermined path in the direction of arrow 28. FIG. 4 shows a cross-sectional view of multiple layers of a direct material deposited bead 40a-40b. Once sufficiently cooled, direct material deposition layers are machined, or otherwise mechanically redefined to achieve a desirable dimensional configuration.

The invention has been described herein in an illustrative manner, and it is to be understood that the terminology which has been used is intended to be in the nature of words of description rather than of limitation. Obviously, many modifications and variations of the invention are possible in my other above teachings. The invention can be practiced otherwise there as specifically described within the scope of the appended claims. For example, it should be understood by those of skill in the art that the material used for direct metal deposition process includes polymers, ceramics, and any combination of materials capable of enhancing the physical properties of the substrate 22 while providing a desired dimensional configuration.

What is claimed is:

1. A method of performing direct material deposition onto a metallic substrate, comprising the steps of:
providing a source of an energy beam and a nozzle for cooperably delivering material relative to the energy beam generated by the source;
creating a melt pool on the metallic substrate with the energy beam and moving the source of the energy beam and nozzle along a predetermined path for generating a material deposition bead upon the substrate;
providing a pre-heater being cooperatively controlled with the source of the energy beam and the nozzle;
moving the pre-heater along the path preceding the energy beam for heating the metallic substrate prior to generating the melt pool; and
the nozzle infusing the melt pool with material for creating a direct material deposition bead upon the metallic substrate.

2. The method set forth in claim 1, wherein said step of providing a pre-heater is further defined by providing an induction heater.

3. The method set forth in claim 1, wherein said step of heating the metallic substrate prior to generating the melt pool is further defined by heating the metallic substrate to a temperature below its solidus state and/or melting point of the metallic substrate.

4. The method set forth in claim 1, wherein said step of heating the metallic substrate to generating the melt pool is further defined by heating the metallic substrate to its plastic state.

5. The method set forth in claim 1, wherein said step of heating the metallic substrate prior to generating the melt pool is further defined by pre-heating an area of the metallic substrate that exceeds an area defined by the melt pool.

6. The method set forth in claim 1, further including the step of simultaneously heating the substrate with the pre-heater while generating the melt pool with the source of heat energy.

7. The method set forth in claim 1, further including the step of re-heating a first direct material deposition bead with the pre-heater prior to depositing a second direct material deposition bead over first direct material deposition bead.

8. The method set forth in claim 1, further including the step of creating a direct material deposition bead upon the metallic substrate is further defined by creating a plurality of direct material deposition beads thereupon and intermittently re-heating the direct material deposition beads with the pre-heater.

9. The method set forth in claim 1, wherein infusing the melt pool with material for creating a direct material deposition bead is further defined by infusing alloys and non-metallic components for creating the direct metal deposition bead.

10. The method set forth in claim 1, wherein said step of providing a source of an energy beam is further defined by providing one of a laser beam, an electron beam, a tungsten arc, or a plasma jet.

11. The method set forth in claim 1, wherein said step of providing a pre-heater is further defined by providing a heating coil substantially circumscribing the providing a source of an energy beam and a nozzle thereby heating a periphery of the metallic substrate located below the nozzle.

12. A method of performing direct metal deposition on a metallic substrate, comprising the steps of:
induction heating the substrate for raising a temperature of the substrate to about its liquidus temperature thereby forming a heated zone upon the substrate;
using an energy beam for forming a melt pool in the heated zone of the substrate;
infusing the melt pool with metallic powder; and
moving the energy beam along a predetermined path thereby causing the melt pool to migrate within the heated zone while infusing the melt pool with the metallic powder thereby developing a first bead formed from the metallic powder upon the metallic substrate.

13. The method set forth in claim 12, wherein said step of induction heating the substrate is further defined by providing a pre-heater for induction heating the substrate.

14. The method set forth in claim 13, wherein said step of moving the energy beam along a predetermine path is further defined by simultaneously moving the pre-heater along the predetermined path with the energy beam.

15. The method set forth in claim 14, wherein said step of simultaneously moving the pre-heater along the predetermined path with the energy beam is further defined by the pre-heater preceding the energy beam along the predetermined path.

16. The method set forth in claim 12, wherein said step of infusing the melt pool with metallic powder is further defined by infusing the melt pool with alloy, ceramics, polymers, and combinations thereof.

17. The method set forth in claim 12, wherein said step of induction heating the substrate for raising a temperature of the substrate is further defined by raising the temperature of the substrate below its liquidus temperature or melting point.

18. The method set forth in claim 12, wherein said step of moving the energy beam along a predetermined path thereby causing the melt pool to migrate within the heated zone is further defined by moving the energy beam over the bead formed by the metallic powder for generating second bead upon the first bead.

19. The method set forth in claim 12, wherein said step of generating second bead upon the first bead is further defined by induction heating the first bead prior to the energy beam generating a melt pool on the first bead.

20. The method set forth in claim 19, wherein said step of induction heating the first bead is further defined by induction heating the first bead to a temperature that does not exceed the solidus temperature of the alloy comprising the first bead.
